(19) United States
(12) Patent Application Publication
(10) Pub. No.: US 2013/0056530 A1
(43) Pub. Date: Mar. 7, 2013

(54) ELECTRONIC DEVICE

(71) Applicant: Yukiko Yokoyama, Suntou-gun (JP)

(72) Inventor: Yukiko Yokoyama, Suntou-gun (JP)

(73) Assignee: TOSHIBA TEC KABUSHIKI KAISHA, Tokyo (JP)

(21) Appl. No.: 13/603,559

(22) Filed: Sep. 5, 2012

(30) Foreign Application Priority Data
Sep. 6, 2011 (JP) 2011-193689

(51) Int. Cl. G07G 1/12

(52) U.S. Cl. 235/3

(57) ABSTRACT

An electronic device comprises an input section arranged in a main body, a printing section which is arranged in the main body at the position adjacent to the input section and holds a continuous-feed paper in its interior and prints various information onto the continuous-feed paper, a connecting member which is connected to the main body via a first shaft at the position adjacent to the input section and the printing section and a display section which is connected to the connecting member via the second shaft. The display section is located at the position where the transfer of the continuous-feed paper into and from the printing section is impeded in usual usage state, and the continuous-feed paper can be transferred into and from the printing section by the action of the connecting member via the first shaft and the action of the display section via the second shaft.

### CROSS-REFERENCE TO RELATED APPLICATION

This application is based upon and claims the benefit of priority from Japanese Patent Application No. 2011-193689, filed Sep. 6, 2011, the entire contents of which are incorporated herein by reference.

### FIELD

Embodiments described herein relate to an electronic device.

### BACKGROUND

Previously, in a supermarket or a retail store, in order to conduct a commodity sales data treatment, an electronic device such as POS (Point of Sales) terminal having a screen for operator and a screen for customer is used.

The POS terminal is a terminal which is arranged at a clearing area and used for sales treatment by a cashier, and a keyboard is arranged at an upper side of its main body.

In the vicinity of approximate middle of the upper side of the main body, a salesclerk-oriented display section is arranged in a manner of facing the keyboard side and being able to adjust an angle in a vertical direction via a shaft. In the vicinity of an end of a back side of the upper side of the main body, a customer-oriented display section is arranged in a manner of facing the side opposite to the salesclerk-oriented display section and being able to adjust an angle in a horizontal direction via a shaft.

In the interior of the main body of the POS terminal and in the vicinity of the keyboard, a receipt printer and a journal printer are arranged at the upper side of the main body in a parallel fashion. A cover for transferring a continuous-feed paper into and from the receipt printer and a cover for transferring the continuous-feed paper into and from the journal printer are arranged side by side at the upper side of the main body. In addition, a receipt outlet for the receipt printer is arranged in the cover.

### BRIEF DESCRIPTION OF THE DRAWINGS

FIG. 1 is a front perspective view showing a POS terminal according to the present embodiment.

FIG. 2 is a back perspective view of the above-described POS terminal.

FIG. 3 is a front perspective view showing the state of the salesclerk-oriented display section of the above-described POS terminal being reversed.

FIG. 4 is a side view showing the usage state of above-described POS terminal.

FIG. 5 is a side view showing the half-way state of the salesclerk-oriented display section of the above-described POS terminal being reversed.

FIG. 6 is a side view showing the state of the salesclerk-oriented display section of the above-described POS terminal being reversed.

### DETAILED DESCRIPTION

The electronic device according to the embodiment comprises a main body, an input section arranged in the main body, a printing section which is arranged in the main body at the position adjacent to the input section and holds a continuous-feed paper in its interior and prints various information onto the continuous-feed paper, a connecting member which is connected to the main body via a first shaft at the position adjacent to the input section and the printing section and a display section which is connected to the connecting member via the second shaft, wherein the display section is located at the position where the transfer of the continuous-feed paper into and from the printing section is impeded in usual usage state, and the continuous-feed paper can be transferred into and from the printing section by the action of the connecting member via the first shaft and the action of the display section via the second shaft.

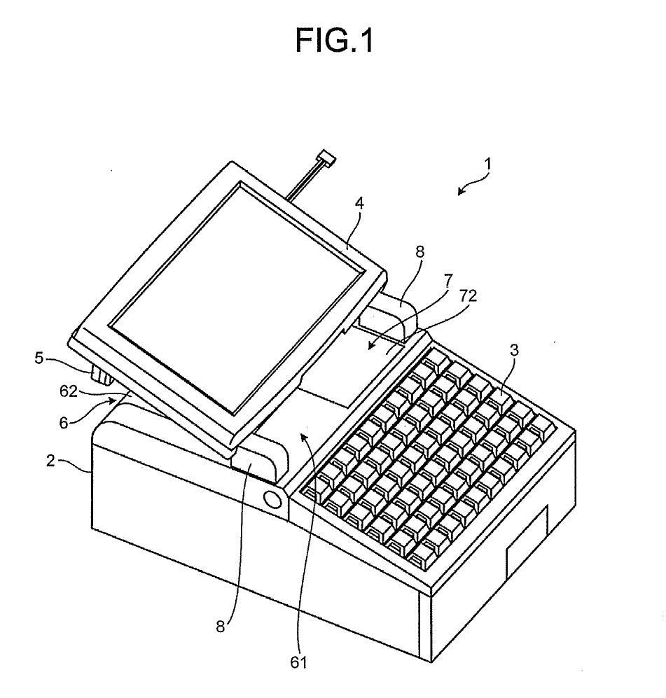

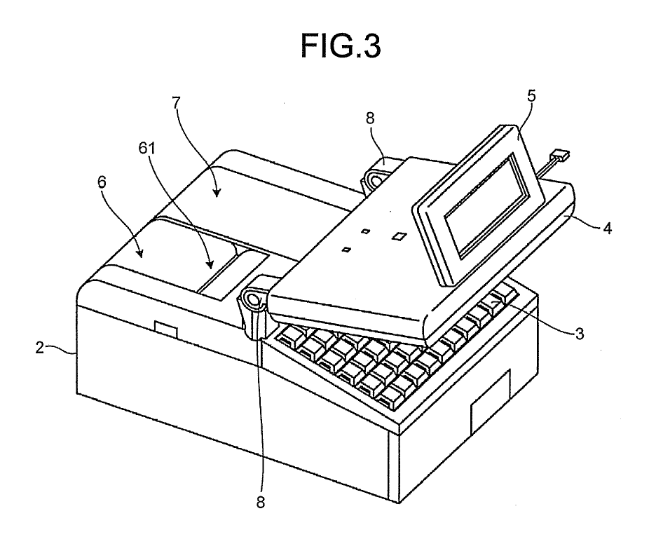

Hereinafter, the POS terminal as an example of the electronic device according to the embodiment is illustrated with reference to FIGS. 1-6.

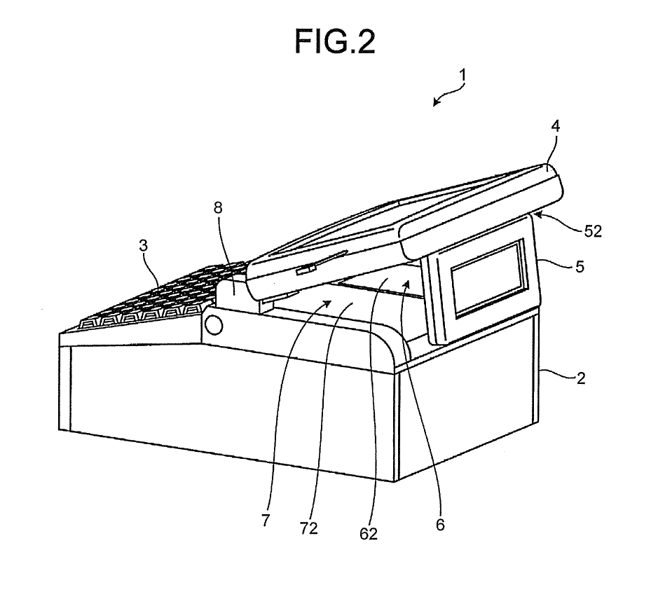

FIGS. 1 and 2 are the front perspective view and the back perspective view showing a schematic brief configuration of the POS terminal according to the embodiment.

The POS terminal 1 is an electronic device which is installed at a checkout area of a store and conducts the registration processing and the account processing for the commodity purchased by the customer. As shown in FIGS. 1 and 2, the POS terminal 1 comprises a main body 2, a keyboard 3, a salesclerk-oriented display section 4, a customer-oriented display section 5, a connecting member 8, a receipt printer 6, and a journal printer 7.

In the interior of the main body 2, an information-processing section (not shown) for conducting various information-processing, or a storage section (not shown) for storing various information are arranged.

At one end side of the upper side of the main body 2, a keyboard 3 as an input section which has various function keys for conducting various operations by the salesclerk is arranged.

In the upper side of the main body 2 and at the position adjacent to the keyboard 3, a salesclerk-oriented display section 4 which displays various information such as processing details etc. to the salesclerk is installed via two connecting members 8.

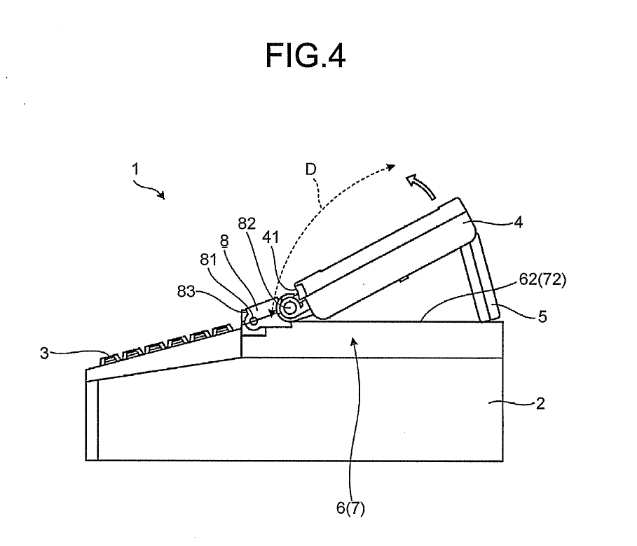

The connecting members 8 are connected with the main body 2 via a first shaft 81 (referring to FIGS. 4 to 6) in a front-back direction (a direction in which the keyboard 3 is connected with the receipt printer 6 or the journal printer 7) in a manner of being able to adjust angle meanwhile connected with the salesclerk-oriented display section 4 via a second shaft 82 (referring to FIGS. 4 to 6) in a front-back direction in a manner of being able to adjust angle. That is, the salesclerk-oriented display section 4 is installed on the main body 2 via the connecting section 8 in the front-back direction in a manner of being able to adjust angle. Then, the supply of electric power or various display data from the main body 2 to the salesclerk-oriented display section 4 is conducted via the connecting member 8. In addition, a given resistance force is applied to the rotation motion of the second shaft 82. By the resistance force, the salesclerk-oriented display section 4 can adjust its angle relative to the connecting section 8 and maintain a given angle.

The customer-oriented display section 5 is connected to an end of the side opposite to the side connected with the connecting member 8 of the salesclerk-oriented display section 4 via a shaft 52 in the front-back direction in a manner of being able to adjust angle. In a usual usage state of the POS terminal 1, the customer-oriented display section 5 is located above the receipt printer 6 and the journal printer 7 described below.

The customer-oriented display section 5 displays various information such as purchased commodity or billing amount etc. to the customer. The supply of electric power or various display data from the main body 2 to the customer-oriented display section 5 is conducted via the connecting member 8 and the salesclerk-oriented display section 4. As a result, even if the customer-oriented display section 5 is not directly arranged on the main body 2, the supply of electric power or various display data are possible. In addition, a given resistance force is applied to the rotation motion of the shaft 52. By this resistance force, the salesclerk-oriented display section 4 can adjust an angle relative to the connecting member 8 and can maintain a given angle.

The customer-oriented display section 5 is arranged in a manner of being connected to the salesclerk-oriented display section 4 such that it becomes unnecessary to ensure the space for arranging the customer-oriented display section 5 on the upper side of the main body 2, and the POS terminal 1 can be downsized in a planar direction.

In the usual usage state of the POS terminal 1, the customer-oriented display section 5 is located above the receipt printer 6 and the journal printer 7 described below, and does not project from the main body 2 in the planar direction. Therefore, the POS terminal 1 can be downsized in the planar direction.

As shown in FIG. 1 to FIG. 3, in the lower part of the salesclerk-oriented display section 4 and at the position adjacent to the keyboard 3, the receipt printer 6 and the journal printer 7 are arranged side by side in the planar direction.

The receipt printer 6 prints the purchased commodity items or their total amount etc. onto the continuous-feed paper and send it out as the receipt. The receipt printer 6 comprises a storage section (not shown) which holds a roll-shaped continuous-feed paper in its interior, a printing section (not shown) which prints onto the continuous-feed paper, a paper feed section (not shown) which transports the continuous-feed paper from the storage section to the exterior of the receipt printer 6 through the printing section, and a cover 62 which covers these sections. The receipt made by printing on the continuous-feed paper is discharged from the receipt outlet 61 arranged in the cover 62.

The journal printer 7 prints the data such as one-day sales result which is stored in the memory section arranged in the interior of the main body 2 of the POS terminal 1 onto the continuous-feed paper and sends it as a journal. The journal printer 7 comprises a storage section (not shown) which holds the roll-shaped continuous-feed paper in its interior, a printing potion (not shown) which prints onto the continuous-feed paper, a rewinding section (not shown) which rewinds the print finished continuous-feed paper to a roll shape, and a cover 72 which covers these sections.

The receipt printer 6 and the journal printer 7 are arranged adjacent to the keyboard 3. Therefore, the POS terminal 1 can be downsized in the planar direction.

In order to downsize the POS terminal 1 in the planar direction, it is necessary to arrange the components adjacent to each other in the planar direction. On the other hand, in order to ensure operability of the keyboard 3, it is necessary to arrange the salesclerk-oriented display section 4 in a manner of leaving a given interval from the keyboard 3.

Therefore, within the POS terminal 1 according to the present embodiment, the salesclerk-oriented display section 4 is arranged at the upper part of the main body 2 via the connecting member 8 arranged adjacent to the keyboard 3. That is, at the upper part of the main body 2, only the keyboard 3, the connecting member 8, the receipt printer 6, and the journal printer 7 can be arranged adjacent to each other, becoming a configuration with excellent space saving property in the planar direction.

The salesclerk-oriented display section 4 is arranged in the main body 2 via the connecting member 8, accordingly in the usual usage state (referring to FIG. 1), the salesclerk-oriented display section 4 offsets only the connecting member 8 relative to the keyboard 3, thus the operability of the keyboard 3 can be ensured.

The motion of the salesclerk-oriented display section 4 of the POS terminal 1 according to above-described embodiment is illustrated with reference to FIGS. 4-6.

FIG. 4 is a side view showing the usual usage state of the POS terminal 1. At this time, the salesclerk-oriented display section 4 of the POS terminal 1 faces to the salesclerk side meanwhile the customer-oriented display section 5 faces to the customer side. In addition, in this state, the receipt outlet 61 exposes to the salesclerk side across the space formed by the main body 2, the connecting section 8 and the salesclerk-oriented display section 4 (referring to FIG. 1). As a result, the salesclerk can take out with hand the receipt discharged from the receipt outlet 61 across the spaced formed by the main body 2, the connecting section 8 and the salesclerk-oriented display section 4.

However, in the state shown in FIG. 4, within the motion range D of the cover 62 of the receipt printer 6 and the cover 72 of the journal printer 7, there is the salesclerk-oriented display section 4. Therefore, if the covers 62, 72 are opened, them contact the lower hem of the salesclerk-oriented display section 4, accordingly in this state the covers 62, 72 can not be opened and closed, and the roll paper can not be transferred into and from the receipt printer 6 or the journal printer 7. Therefore, in the case of at the time the roll paper is transferred into and from the receipt printer 6 or the journal printer 7 it is necessary to open and close the covers 62, 72, the salesclerk-oriented display section 4 must be evacuated out of the motion range D of the covers 62, 72.

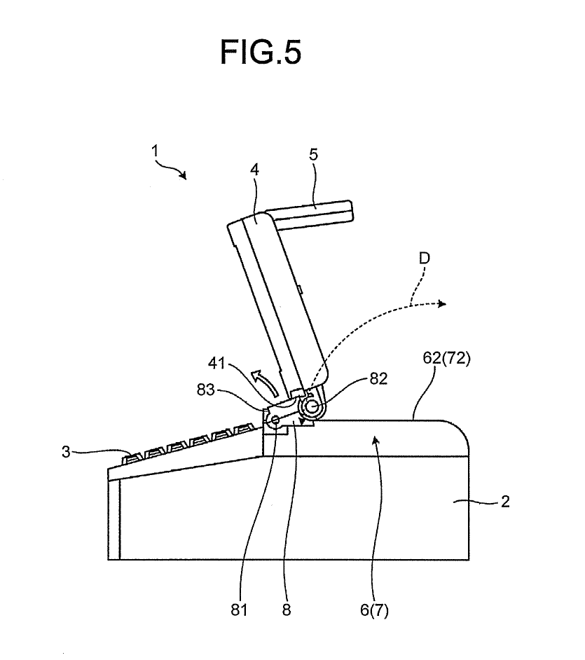

In order to evacuate the salesclerk-oriented display section 4 out of the motion range D of the covers 62, 72, first as shown in FIG. 5, the salesclerk-oriented display section 4 is made to rotate and stand up via the second shaft 82 towards the keyboard 3. At this time, the lower hem 41 of the rotated salesclerk-oriented display section 4 abuts with the connecting member 8, thereby the rotation of the salesclerk-oriented display section 4 is controlled in a state of rotating to a given angle meanwhile this state is maintained by the resistance force against the rotation of the second shaft 82. In addition, the customer-oriented display section 5 connected to the salesclerk-oriented display section 4 also moves with the movement of the salesclerk-oriented display section 4, the customer-oriented display section 5 evacuate out of the motion range D of the covers 62, 72.

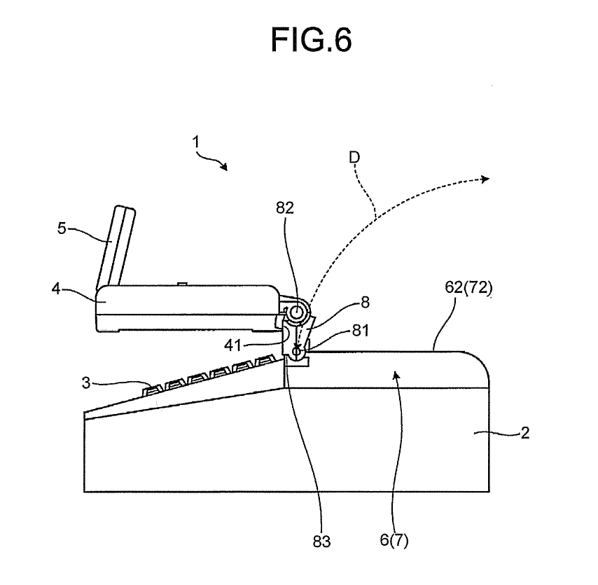

As shown in FIG. 6, the connecting member 8 is made to rotate and stand up via the first shaft 81 in the direction of the keyboard 3. At this time, the rotation of the connecting member 8 via the first shaft 81 is controlled in a state to a given angle due to abutting of an end face 83 of the connecting member 8 with the superior surface of the main body 2. By the rotation motion of the connecting member 8, the salesclerk-oriented display section 4 connected with the connecting member 8 can also further moves from the state of FIG. 5 towards the side of the keyboard 3 and evacuate out of the motion range D of the covers 62, 72. In addition, following the salesclerk-oriented display section 4, the customer-oriented display section 5 may also further move from the state of FIG. 5 towards the side of the keyboard 3.

Thus, the salesclerk-oriented display section 4 and the customer-oriented display section 5 can both evacuate out of the motion range D of the covers 62, 72, and the covers 62, 72 can be opened and closed, and the roll paper can be transferred into and from the receipt printer 6 or the journal printer 7. In addition, in this state, a given space is formed between the salesclerk-oriented display section 4 and the keyboard 3 by the connecting member 8, accordingly an incorrect operation of the keyboard 3 due to the contact of the salesclerk-oriented display section 4 can be prevented.

In accordance with the POS terminal 1 according to the above-described embodiment, the salesclerk-oriented display section 4 rotates and stands up via the second shaft 82 towards the keyboard 3, and the connecting member 8 further rotates and stands up via the first shaft 81 towards the keyboard 3. Thus, in the usual usage state, the salesclerk-oriented display section 4 and the customer-oriented display section 5 connected therewith which are located in the motion range D of the covers 62, 72 can evacuate out of the motion range D of the covers 62, 72.

As a result, in the usual usage state, the salesclerk-oriented display section 4 and the customer-oriented display section 5 can be arranged in a manner of being located within the motion range D of the covers 62, 72. That is, because previously the salesclerk-oriented display section 4 and the customer-oriented display section 5 are arranged out of the motion range D, the given space required between the salesclerk-oriented display section 4 or the customer-oriented display section 5 and the covers 62, 72 can be omitted, and the POS terminal 1 can be downsized in the planar direction.

When the salesclerk-oriented display section 4 and the customer-oriented display section 5 are evacuated out of the motion range D of the covers 62, 72, first the salesclerk-oriented display section 4 and the connecting member 8 are folded around the center i.e. the second shaft 82, accordingly a compact state is formed in which the salesclerk-oriented display section 4 is adjacent to the connecting member 8. Then, the salesclerk-oriented display section 4 and connecting member 8 which have become to a compact state are moved by the movement around the center i.e. the first shaft 81, accordingly the motion range at the time of the salesclerk-oriented display section 4 and the customer-oriented display section 5 are evacuated out of the motion range D of the covers 62, 72 can be reduced. In this way, the motion range of the salesclerk-oriented display section 4 and the customer-oriented display section 5 is reduced, accordingly the space required for the arrangement of the POS terminal 1 can be reduced.

The above-described embodiment is presented as an example, and it is not intended to limit the scope of the invention. The novel embodiment can be implemented in other various forms, and various omissions, replacements, and modifications can be conducted without departing from the gist of the invention. The embodiment or its variations are included in the scope or the gist of the invention meanwhile included in the invention described in the claims and their equivalents.

For example, in the above-described embodiments, the salesclerk-oriented display section is connected to the main body by tow connecting members, but the invention is not limited to this, for example they may also be connected by using 1 or 3 or more connecting members. In this case, the POS terminal can similarly be downsized in the planar direction.

In the above-described embodiments, the keyboard as the input section is arranged in the upper part of the main body, but it may be omitted, and the salesclerk-oriented display section is used as a touch panel which also serves as the input section.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device, comprising:
a main body;
an input section arranged in the main body;
a printing section which is arranged in the main body at the position adjacent to the input section and holds a continuous-feed paper in its interior and prints various information onto the continuous-feed paper;
a connecting member which is connected to the main body via a first shaft at the position adjacent to the input section and the printing section; and
a display section which is connected to the connecting member via the second shaft, wherein
the display section is located at the position where the transfer of the continuous-feed paper into and from the printing section is impeded in usual usage state, and the continuous-feed paper can be transferred into and from the printing section by the action of the connecting member via the first shaft and the action of the display section via the second shaft.

2. The electronic device according to claim 1, wherein
the display section and the input section are spaced apart in the state when the display section moves to the input section.

3. The electronic device according to claim 1, wherein
the printing section includes a receipt printer which prints on the continuous-feed paper and issues the receipt, and the receipt issued from the receipt printer passes through a space formed by the main body, the connecting member and the display section in usual usage state.

4. The electronic device according to claim 1, wherein
the display section includes a salesclerk-oriented display section which is connected to the connecting member via the second shaft, a customer-oriented display section which is connected to the salesclerk-oriented display section via a third shaft and faces to a direction different from the salesclerk-oriented display section.

5. The electronic device according to claim 4, wherein
the supply of electric power and display data to the customer-oriented display section is conducted via the connecting member and the salesclerk-oriented display section from the main body.

6. The electronic device according to claim 4, wherein
the customer-oriented display section is located above the printing section in usual usage state.
